(19) United States
(12) Patent Application Publication
(10) Pub. No.: US 2025/0124256 A1
(43) Pub. Date: Apr. 17, 2025

(54) Efficient Knowledge Distillation Framework for Training Machine-Learned Models

(71) Applicant: Google LLC, Mountain View, CA (US)

(72) Inventors: Rishabh Agarwal, Montreal (CA); Nino Jean Vieillard, Paris (FR); Matthieu Florent Geist, Ancy-Dornot (FR); Olivier Frédéric Bachem, Zurich (CH)

(21) Appl. No.: 18/486,792

(22) Filed: Oct. 13, 2023

(51) Int. Cl. G06N 3/0455; G06N 3/092

(52) U.S. Cl. CPC G06N 3/0455; G06N 3/092

(57) ABSTRACT

An example method is provided for training a machine-learned student sequence processing model, the method comprising: obtaining a respective input; obtaining, from the student machine-learned sequence processing model, a respective output corresponding to the respective input; generating a multiscale refinement objective configured to jointly distill knowledge from a teacher machine-learned sequence processing model and reinforce preferred behavior of the student machine-learned sequence processing model, wherein the multiscale refinement objective comprises: a first component based on a divergence metric characterizing, for the respective input, a comparison of a plurality of predictions of the student machine-learned sequence processing model to a plurality of predictions of the teacher machine-learned sequence processing model; and a second component based on a reinforcement learning signal associated with the respective output; and updating the machine-learned student sequence processing model based on the multiscale refinement objective.

### FIELD

The present disclosure relates generally to machine learning. More particularly, the present disclosure relates to efficiently distilling machine-learned models based on one or more reference machine-learned models.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

In an example aspect, the present disclosure provides an example computer-implemented method for training a machine-learned student sequence processing model. The example method can include obtaining a respective input. The example method can include obtaining, from the student machine-learned sequence processing model, a respective output corresponding to the respective input. The example method can include generating a multiscale refinement objective configured to jointly distill knowledge from a teacher machine-learned sequence processing model and reinforce preferred behavior of the student machine-learned sequence processing model. In the example method, the multiscale refinement objective can include a first component based on a divergence metric characterizing, for the respective input, a comparison of a plurality of predictions of the student machine-learned sequence processing model to a plurality of predictions of the teacher machine-learned sequence processing model. In the example method, the multiscale refinement objective can include a second component based on a reinforcement learning signal associated with the respective output. The example method can include updating the machine-learned student sequence processing model based on the multiscale refinement objective.

In the example method, the divergence metric can be evaluated using a student value generated by the machine-learned student sequence processing model for one or more portions of the respective output based on the respective input, the value corresponding to a student probability of the one or more portions of the respective output conditioned on the respective input. In the example method, the divergence metric can be evaluated using a teacher value generated by the machine-learned teacher sequence processing model for the one or more portions of the respective output based on the respective input, the teacher value corresponding to a teacher probability of the one or more portions of the respective output conditioned on the respective input.

The example method can include, for each portion of a plurality of portions of the respective output: determining a portion-specific divergence metric that characterizes a similarity between a student probability distribution over a set of candidate output portions and a teacher probability distribution over the set of candidate output portions, wherein each of the student probability distribution and the teacher probability distribution are conditioned on the respective input and one or more portions of the respective output that precede the portion; and aggregating the plurality of portion-specific divergence metrics for the respective output to obtain the first component.

In the example method, the teacher probability distributions for each of the portion-specific divergence metrics can be generated at least partially in parallel by the machine-learned teacher sequence processing model.

In the example method, the multiscale refinement objective can include one or more weighting parameters that weight the respective contributions of the first component and the second component.

In the example method, the reinforcement learning signal can include data indicating human feedback on an overall quality of the respective output.

In the example method, the reinforcement learning signal can include data indicating a score generated by a machine-learned reward model. In the example method, the score can indicate an overall quality of the respective output.

In the example method, evaluating the divergence metric can include determining a value of a mixture distribution corresponding to a mixture of a student probability distribution of the machine-learned student sequence processing model and a teacher probability distribution of the machine-learned teacher sequence processing model. In the example method, evaluating the divergence metric can include computing a first divergence component that characterizes a divergence of the student probability distribution with respect to the mixture distribution. In the example method, evaluating the divergence metric can include computing a second divergence component that characterizes a divergence of the teacher probability distribution with respect to the mixture distribution. In the example method, evaluating the divergence metric can include evaluating the divergence metric based on a combination of the first divergence component and the second divergence component.

In the example method, evaluating the divergence metric based on the first divergence component and the second divergence component can include computing, using a weighting parameter, a weighted combination of the first divergence component and the second divergence component. In the example method, adjusting the weighting parameter can cause the divergence metric to interpolate between a mode-seeking behavior and a mean-seeking behavior. The example method can include adjusting the weighting parameter based on a desired output diversity for a type of task. In the example method, the weight can be a learned hyperparameter during training.

In the example method, the machine-learned teacher sequence processing model can have been not trained using reinforcement learning.

In the example method, the machine-learned student sequence processing model can have been fine-tuned to achieve a baseline threshold of performance before training with the multiscale refinement objective.

In the example method, the machine-learned student sequence processing model can be characterized by a first number of parameters. In the example method, the machine-learned teacher sequence processing model can be characterized by a second number of parameters. In the example method, the second number of parameters can be larger than the first number of parameters. In the example method, the second number of parameters can be at least 30 times the first number of parameters.

The example method can include receiving, from a client computing system, a request to perform an inference task based on input data. The example method can include obtaining the respective input from the input data. The example method can include generating the respective output using the machine-learned student sequence processing model. The example method can include returning, to the client computing system and responsive to the request, output data based on the respective output. The example method can include receiving, from the client computing system, feedback data. The example method can include determining the reinforcement learning signal based on the feedback data.

The example method can include in an online process, receiving the request and returning the output data. The example method can include, in an offline process, obtaining the plurality of predictions of the teacher machine-learned sequence processing model and updating the machine-learned student sequence processing model based on the multiscale refinement objective.

In an aspect, the present disclosure provides an example computing system. The example computing system can include one or more processors and one or more non-transitory computer-readable media storing instructions that are executable by the one or more processors to cause the computing system to perform one or more example operations. The example operations can include obtaining a respective input. The example operations can include obtaining, from a student machine-learned sequence processing model, a respective output corresponding to the respective input. The example operations can include generating a multiscale refinement objective configured to jointly distill knowledge from a teacher machine-learned sequence processing model and reinforce preferred behavior of the student machine-learned sequence processing model. The multiscale refinement objective can include a first component based on a divergence metric characterizing, for the respective input, a comparison of a plurality of predictions of the student machine-learned sequence processing model to a plurality of predictions of the teacher machine-learned sequence processing model. The multiscale refinement objective can include a second component based on a reinforcement learning signal associated with the respective output. The example operations can include updating the machine-learned student sequence processing model based on the multiscale refinement objective.

In an aspect, the present disclosure provides an example one or more non-transitory computer-readable media storing a machine-learned student sequence processing model that was distilled from a larger teacher machine-learned sequence processing model. In the example one or more non-transitory computer-readable media, the machine-learned student sequence processing model was trained by obtaining a respective input; obtaining, from the student machine-learned sequence processing model, a respective output corresponding to the respective input; generating a multiscale refinement objective configured to jointly distill knowledge from the teacher machine-learned sequence processing model and reinforce preferred behavior of the student machine-learned sequence processing model, wherein the multiscale refinement objective includes: a first component based on a divergence metric characterizing, for the respective input, a comparison of a plurality of predictions of the student machine-learned sequence processing model to a plurality of predictions of the teacher machine-learned sequence processing model; and a second component based on a reinforcement learning signal associated with the respective output; and updating the machine-learned student sequence processing model based on the multiscale refinement objective.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system according to example embodiments of the present disclosure.

FIG. 2A depicts a block diagram of an example training system according to example embodiments of the present disclosure.

FIG. 2B depicts a block diagram of an example training system according to example embodiments of the present disclosure.

FIG. 2C depicts a block diagram of an example training system according to example embodiments of the present disclosure.

FIG. 2D depicts a block diagram of an example training system according to example embodiments of the present disclosure.

FIG. 3 depicts a flowchart diagram of an example training sequence according to example embodiments of the present disclosure.

FIG. 4 depicts a flowchart diagram of an example sequence for computing a divergence metric according to example embodiments of the present disclosure.

FIG. 5 is a flow chart diagram illustrating an example method for training a machine-learned model according to example implementations of aspects of the present disclosure;

FIG. 6 is a chart showing example test results for an example implementation according to the present disclosure;

FIG. 7 is a block diagram of an example processing flow for using machine-learned model(s) to process input(s) to generate output(s) according to example implementations of aspects of the present disclosure;

FIG. 8 is a block diagram of an example sequence processing model according to example implementations of aspects of the present disclosure;

FIG. 9 is a block diagram of an example technique for populating an example input sequence for processing by a sequence processing model according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure. Reference numerals that are repeated across plural figures are intended to identify various implementations of the same elements.

### DETAILED DESCRIPTION

### Overview

Generally, the present disclosure is directed to systems and methods for efficiently distilling a machine-learned model based on a reference model. Knowledge distillation includes techniques for training a smaller student model to learn from a more powerful expert teacher model. Knowledge distillation can be useful for decreasing a size of machine-learned models to reduce their inference cost and memory footprint. However, in some instances, the smaller student model may not be expressive enough to completely match a teacher's output distribution. This misalignment can lead to situations in which the student model may be unable to adequately learn from the teacher model, leading to suboptimal distillation results. Advantageously, example implementations of the present disclosure can efficiently train a student model based on a larger teacher model while mitigating the effect of any output distribution misalignment. In this manner, for instance, example implementations can train a machine-learned model capable of performing inference at reduced computational cost.

Advantageously, to help align the student model and the teacher model, example implementations according to the present disclosure can train the student model by using the outputs of the teacher model to “correct” outputs organically generated by the student model. For example, the student model can include a machine-learned sequence processing model configured to generate sequences of information based on input context information. The student model can generate new data elements in the sequence. The teacher model can process the sequence generated by the student model and generate, for each data element generated by the student model, an example of how the teacher model would have processed the sequence at that step. In this manner, for instance, the student model can explore its own output space by organically generating sequences while also receiving feedback on its performance from the teacher model.

Example implementations according to the present disclosure can also integrate knowledge distillation updates with reinforcement learning. For instance, a reinforcement learning regimen can be applied to a model as form of fine-tuning to refine an alignment of a model's behavior to a desired performance profile. For example, traditional approaches might generally distill a larger reference model as a final step, such as using the outputs of a finalized teacher model (e.g., a teacher model having completed its training). However, the student model can deviate from the behavior of the teacher model, such that the student model might benefit from further fine-tuning itself.

Advantageously, knowledge distillation training signals can be combined with reinforcement learning signals to compute a multiscale refinement objective that enables the student model to be fine-tuned with a reinforcement learning signal while also receiving correction from the teacher model. Both training signals can be based on the same inference(s). For instance, the reinforcement learning feedback can be determined based on an output of the student model, and the same output of the student model can be processed by the teacher model to generate the corrective distillation signal. In this manner, for instance, example implementations of the present disclosure can achieve improved efficiencies in training smaller, more performant machine-learned models by enabling both distillation and reinforcement learning to use the same inference passes.

Further, the multiscale refinement objective can be “multiscale” by providing feedback signals on a student model output at different scope. For instance, a teacher model can evaluate each portion of a student model output. A micro-scale feedback signal can be computed based on the teacher model's portion-by-portion evaluation. For example, for a student model configured to autoregressively generate sequences of information, a teacher model can predict how it would have handled each prediction scenario faced by the student (e.g., the predictions the teacher would have made in view of the context processed by the student at that time step). A macro-scale feedback signal can be computed based on a reinforcement learning reward associated with the entire output. For instance, the entire output of the student model can be processed by a reward generator that generates a reward indicating a quality of the output. For instance, the reward generator can output a reward based on how well an output satisfies a query or instruction provided in an input. In this manner, for instance, a multiscale refinement objective can provide a training signal that encompasses a range of granularity.

Some traditional reinforcement learning techniques have combined a reinforcement learning signal with a comparison to an anchor model that is a checkpointed version of the model being trained. This has been done to prevent the training from causing the model being trained to stray too far from the performance of the anchor. In other words, such techniques can inhibit the learning of new information by biasing the training updates toward the prior checkpoint.

In contrast, joint distillation and reinforcement learning can accelerate the learning process for the model being trained by providing new information to the model at multiple scales. The distillation feedback can correct individual reasoning errors of the model being trained while the reinforcement learning can provide an overall quality signal for the model output. In this manner, for instance, both feedback signals can work together to enable the model being trained to receive granular correction within the context of a larger goal-high quality outputs more generally.

Furthermore, by directly fine-tuning the student model during distillation, a teacher model that has not been fine-tuned (or fine-tuned fewer iterations) can be used for distillation. In various implementations, this can achieve substantial efficiencies. For instance, performing inference using a large teacher model can be computationally expensive. Performing update iterations can also be expensive. By jointly distilling the teacher model into the student model while fine-tuning the student model (e.g., with a reinforcement learning signal), the benefit of fine-tuning can be directly conferred on the student model instead of indirectly flowing through distillation. In this manner, for instance, improved student model performance can be achieved with greater efficiency.

The corrective feedback from the teacher model can be obtained by comparing an output of the student model and an output of the teacher model. The output can be a distribution over an output vocabulary. A student model can be trained based on a comparison between an output distribution of the student model and an output distribution of the teacher model. The output distributions can characterize probabilities over a set of possible output values. The comparison can include a divergence metric computed between a student probability distribution and a reference probability distribution. In some instances, a student model can be trained by optimizing an objective function comprising the divergence metric (e.g. by minimizing a divergence between the student and teacher models). Example divergence metrics described herein can distill student models in a manner robust to distribution mismatches between the student and teacher.

In some instances, a reinforcement learning signal can be generated based on an evaluation of one or more outputs generated by the student. In such instances, the student can be trained using an objective function based on a combination of the reinforcement learning signal and the comparison between the student probability distribution(s) and the teacher probability distribution(s). In some instances, this technique can permit reinforcement learning to be performed simultaneously with model distillation, using the same input data and based on the same outputs generated by the student. As described above, this can have the technical effect and benefit of reducing the computational cost (e.g. electricity cost) of performing model distillation and reinforcement learning by reducing the total number of inferences that must be made by the student model.

Example implementations of the present disclosure achieve various technical effects and benefits using a multiscale refinement objective. In some instances, systems and methods of the present disclosure can achieve better technical performance than prior systems and methods for a variety of common machine-learning tasks (e.g., training models, distributing models, summarization, mathematical reasoning, and machine translation). Additionally, systems and methods of the present disclosure can in some instances achieve similar technical performance at a reduced computational cost (e.g. reduced electricity usage) compared to prior systems and methods.

In some example experiments involving summarization, machine-learned models trained according to the present disclosure achieved higher scores on summarization metrics (e.g. higher overlap of bigrams between model-generated summaries and reference summaries) than similar prior models (e.g. having the same size and architecture) trained in other ways. Additionally, some machine-learned models trained according to the present disclosure achieved higher entailment scores than a much larger (e.g. 12 times as many parameters) machine-learned model trained in other ways. This improved technical performance can, in some instances, permit systems and methods of the present disclosure to perform the same tasks (e.g. achieve the same bigram-overlap and entailment scores) of prior work using less computationally expensive machine-learned models (e.g. models having a smaller parameter count) than prior work.

In some example experiments involving summarization, machine-learned models trained according to the present disclosure achieved similar or better performance (e.g. higher bigram-overlap scores) using fewer training iterations than prior machine-learned models. In some instances, machine-learned models of the present disclosure can be trained on less than one percent (e.g. 0.5 percent) of the training examples used to train prior machine-learned models of the same size and architecture, and can still achieve better technical performance than the fully trained (100 percent of training examples) prior models. Thus, systems and methods of the present disclosure can reduce computational costs (e.g. electricity usage) and other costs (e.g. data collection costs) associated with training machine-learned models by enabling similar performance using fewer training iterations and less training data.

Additionally, in some example experiments involving summarization, machine-learned models trained according to the present disclosure achieved similar or better performance (e.g. similar bigram-overlap scores) compared to larger models distilled in other ways. For example, in some instances, a 77-million-parameter model trained according to the present disclosure can achieve technical performance (e.g. bigram-overlap score) similar to a 250-million-parameter model trained according to prior methods. It will be appreciated that a smaller model can be operated with less computational expense (e.g. reduced electricity cost) compared to a larger model. Thus, systems and methods of the present disclosure can reduce computational costs associated with operating a machine-learned model by enabling similar performance using a less computationally expensive (e.g. smaller) model.

In some example experiments involving machine translation, machine-learned models trained according to the present disclosure achieved higher scores on translation quality metrics (e.g. metrics comparing model-generated translations to human-generated reference translations) than similar prior models (e.g. having the same size and architecture) trained in other ways. This improved result was seen for multiple model sizes (e.g. 77 million parameters, 250 million parameters). Additionally, because machine-learned model performance can scale with model size, it will be appreciated that methods of the present disclosure can also enable similar-quality machine translation using smaller models than prior training methods. Thus, systems and methods of the present disclosure can reduce computational costs associated with operating a machine-learned model by enabling similar machine translation performance using a less computationally expensive (e.g. smaller) model.

In some example experiments involving mathematical reasoning, machine-learned models trained according to the present disclosure achieved higher accuracy scores on a mathematical reasoning dataset than similar prior models (e.g. having the same size and architecture) trained in other ways. Additionally, in some example experiments, machine-learned models trained according to the present disclosure achieved similar or higher accuracy scores compared to much larger prior models (e.g. 77-million-parameter model of the present disclosure vs. 20-billion-parameter prior model, 250-million-parameter model of the present disclosure vs. 137-billion-parameter prior model). It will be appreciated that a smaller model can be operated with less computational expense (e.g. reduced electricity cost) compared to a larger model. Thus, systems and methods of the present disclosure can reduce computational costs associated with operating a machine-learned model by enabling similar mathematical reasoning performance using a less computationally expensive (e.g. smaller) model.

It will be appreciated that these results are provided by way of example only. A person skilled in the art will recognize that systems and methods of the present disclosure can be applied to other machine learning tasks and can have similar technical effects and benefits when so applied.

A technical effect of example implementations of the present disclosure is increased energy efficiency in performing operations using machine-learned models, thereby improving the functioning of computers implementing such models. For instance, example implementations can provide for more energy-efficient runtime execution or inference. In some scenarios, increased energy efficiency can provide for less energy to be used to perform a given task (e.g., less energy expended to maintain the model in memory, less energy expended to perform calculations within the model, etc.). In some scenarios, increased energy efficiency can provide for more task(s) to be completed for a given energy budget (e.g., a larger quantity of tasks, more complex tasks, the same task but with more accuracy or precision, etc.).

In another example aspect, example implementations can provide for more energy-efficient training operations or model updates. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

With reference now to the Figures, example embodiments of the present disclosure will be discussed in further detail.

### Example Architectures

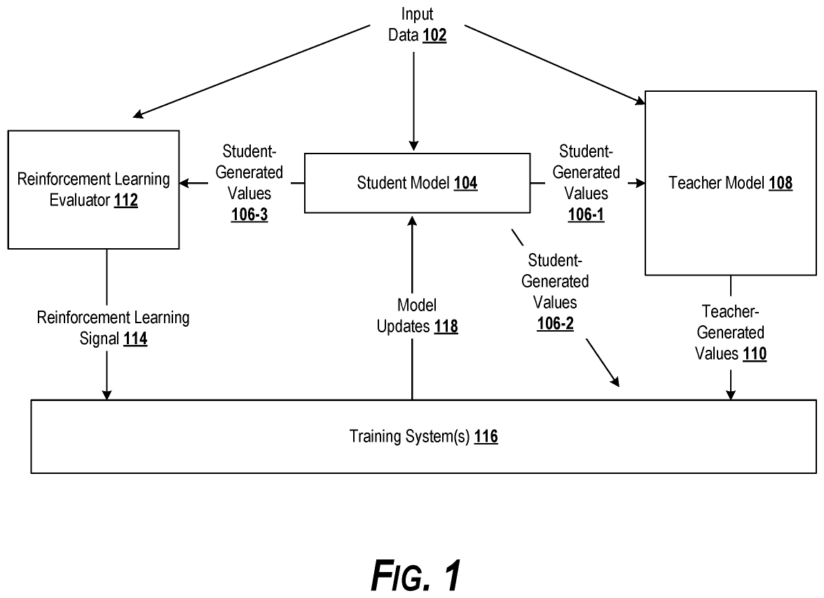

FIG. 1 depicts a block diagram of an example system according to example embodiments of the present disclosure. The input data 102 can be processed by a student model 104. The student model 104 can generate student-generated values 106 (e.g., values 106-1, 106-2, 106-3) based on the input data 102. A teacher model 108 can process the input data 102 and the student-generated values 106-1 to generate teacher-generated values 110, which can provide a reference point for evaluating the student-generated values 106-2. Reinforcement learning evaluator 112 can also process the student-generated values 106-3 (e.g., in view of the input data 102) to evaluate a quality of the output of the student model 104. Reinforcement learning evaluator 112 can generate a reinforcement learning signal 114. Training system(s) 116 can process the student-generated values 106-2, the teacher-generated values 110, and the reinforcement learning signal(s) 114 to generate model updates 118 to train the student model 104 (e.g., using a multi-scale refinement loss).

The input data 102 can be or include various types of data. The input data 102 can include text data, image data, audio data, or combinations thereof. In general, the input data 102 can be or include arbitrary data types represented in a computer-readable format. The input data 102 can be or be represented by serialized or sequential data elements.

The student model 104 can include one or more machine-learned models. The student model 104 can include various model architectures. An example model architecture for student model 104 can include a sequence processing model architecture (e.g., a transformer model). For example, the student model 104 can be configured to receive an input sequence and generate an output sequence. For instance, the student model 104 can be configured to generate an output sequence where elements of the output sequence are predicted based on the elements of the input sequence.

The student model 104 can be trained or not previously trained. For instance, the student model 104 can be a pre-trained model (e.g., pretrained using large-scale unsupervised learning). The student model 104 can be fine-tuned over one or more fine-tuning datasets. The student model 104 can be untrained, such as a model having randomly initialized weights.

The student-generated values 106-1, 106-2, 106-3 (or generally, 106) can be or be based on any value(s) generated by the student model 104. The student-generated values 106 can be final output values or intermediate output values. For example, for a student model 104 configured for natural language processing, a final output value can be a word and an intermediate output value can be a probability associated with that word. For example, more generally, a student model 104 can be configured with a set of candidate outputs (e.g., a vocabulary, a set of classes/categories, tokens, other output element(s), etc.), such that a final output value can be the output element itself (e.g., the word in the vocabulary, the class label, an image mask, etc.) and an intermediate output value can be one or more probabilities distributed over the set of candidate outputs. In general, the student model 104 can generate various different final outputs and various different intermediate output values. In an example, intermediate output values can reflect the internal decision-making of the student model 104 while the final output values can reflect the final decision of the student model 104 (e.g., with respect to a prediction, etc.).

The student-generated values 106-1, 106-2, 106-3 can all be the same. At least one of the student-generated values 106-1, 106-2, 106-3 can be different from another. For example, student-generated values 106-1 can include data in a format consistent with input data 102, so that teacher model 108 can process input data 102 and student-generated values 106-1 together. Student-generated values 106-1 can include data in a format interpretable by teacher model 108. Student-generated values 106-2 can include data in a format consistent with teacher-generated values 110 to facilitate comparison therebetween. Student-generated values 106-3 can include data in a format interpretable by reinforcement learning evaluator 112. In an example, student-generated values 106-3 can include data in a format consistent with input data 102, so that reinforcement learning evaluator 112 can process input data 102 and student-generated values 106-3 to generate a reward.

The teacher model 108 can include one or more machine-learned models. The teacher model 108 can include various model architectures. An example model architecture for teacher model 108 can include a sequence processing model architecture (e.g., a transformer model). For example, the teacher model 108 can be configured to receive an input sequence and generate an output sequence. For instance, the teacher model 108 can be configured to generate an output sequence where elements of the output sequence are predicted based on the elements of the input sequence.

The teacher model 108 can be the same as or different from the student model 104. The teacher model 108 can use one or more model components or model architectures as the student model 104. The teacher model 108 be entirely different from the student model 104. The teacher model 108 can be larger than the student model 104. The student model 104 can have a number of parameters that is smaller (e.g. 5 times, 10 times, 20 times, 30 times, 50 times, 100 times smaller, etc.) than a number of parameters of the teacher model 108. The student model 104 can be characterized by a computing cost (e.g. inference cost, pretraining cost, fine-tuning cost, memory usage, etc.) that is lower than a computing cost of the teacher model 108.

The teacher model 108 can be trained on similar data as compared to the student model 104. For example, the teacher model 108 can be a pretrained model that has already been trained using one or more datasets. The student model 104 can also be previously trained on a same or different dataset(s).

The teacher-generated values 110 can be or be based on any value(s) generated by the teacher model 108. The teacher-generated values 110 can be final output values or intermediate output values. For example, for a teacher model 108 configured for natural language processing, a final output value can be a word and an intermediate output value can be a probability associated with that word. For example, more generally, a teacher model 108 can be configured with a set of candidate outputs (e.g., a vocabulary, a set of classes/categories, tokens, other output element(s), etc.), such that a final output value can be the output element itself (e.g., the word in the vocabulary, the class label, an image mask, etc.) and an intermediate output value can be one or more probabilities distributed over the set of candidate outputs. In general, the teacher model 108 can generate various different final outputs and various different intermediate output values. In an example, intermediate output values can reflect the internal decision-making of the teacher model 108 while the final output values can reflect the final decision of the teacher model 108 (e.g., with respect to a prediction, etc.).

In general, the student-generated values 106 and teacher-generated values 110 can include values selected or configured to facilitate a comparison between a performance of the student model 104 and the teacher model 108 (e.g., values of similar dimensionality, values that correspond to a similar step in an inference process, etc.). For example, the type of values from each of the student and the teacher can be selected or obtained to represent a decision or the rationale for a decision made by the model(s). In this manner, for instance, a comparison of the values can indicate a relative performance difference between the models in making the decision.

A comparison between the student-generated values 106 and the teacher-generated values 110 can facilitate small scale, granular feedback to the student model 104 regarding its performance. For example, an example set of student generated values can correspond to a sequence of output elements generated based on the input data 102. The teacher model 108 can process input data 102 and the student generated-values 104 to, step-by-step through the sequence output by the student model 104, evaluate what output elements the teacher model 108 would have considered at each juncture instead of the element(s) actually output by the student model 104.

The reinforcement learning evaluator 112 can facilitate broader scale feedback for the student model 104 more generally. For instance, the reinforcement learning evaluator 112 can process the student-generated values 106-3 to evaluate an overall quality of the student-generated values 106-3. The reinforcement learning evaluator 112 can evaluate the student-generated values 106-3 in view of the input data 102 to evaluate how well the student-generated values 106-3 overall respond to or execute on the input data 102.

The reinforcement learning signal 114 can be or include a reward or cost generated by the reinforcement learning evaluator 112 based on the student-generated values 106-3. For example, a reward can indicate how well the student-generated values 106-3 respond to or execute on a query or instructions indicated by the input data 102. The reinforcement learning evaluator 112 can generate the reinforcement learning signal 114 using a machine-learned reward model. For example, a machine-learned reward model can be trained to process an input and an output and generate a reward value associated with the output.

In various examples, the reinforcement learning signal 114 can include a signal indicative of a quality (e.g. high quality, low quality) associated with one or more actions taken by the student model 104 (e.g. one or more student-generated values 106-3). In some instances, the quality can be a performance quality associated with one or more tasks (e.g., mathematical accuracy score on a mathematical reasoning task, factual accuracy score on a text generation task, entailment score associated with a summarization task, artistic quality score on a creative content generation task, etc.). In some instances, the reinforcement learning signal 114 can include a signal indicative of a desirability of one or more outcomes caused by the student model 104 (e.g. one or more desirable properties of a generated textual sequence or generated image). The reinforcement learning signal 114 can include, for example, a numerical indicator indicative of quality of an output sequence. In some instances, the reinforcement learning signal 114 can be based on one or more input data 102 and one or more student-generated values 106-3.

A reinforcement learning implementation can include presenting at least one of input data 102 or student-generated values 106-3 to a human user to solicit human feedback on the at least one of input data 102 or student-generated values 106-3. For example, a computing system can actuate the student model 104 to perform one or more tasks (e.g., tasks executed or embodied using output(s) of the student model 104) for a human user. The computing system can determine an interaction with a user interface element indicating feedback associated with performance of the one or more tasks. The reinforcement learning signal 114 can be generated based on the feedback.

The training system(s) 116 can be or include one or more software, firmware, or hardware components configured to process student-generated values 106-2, teacher-generated values 110, and reinforcement learning signal 114 and generate model updates 118. For example, the training system(s) 116 can compute a multiscale refinement objective to evaluate a performance of the student model 104 across multiple output scales.

For instance, one component of a multiscale refinement objective can be based on a comparison of student generated value(s) 106-2 and teacher generated value(s) 110. For example, the training system(s) 116 can compare student generated value(s) 106-2 and teacher generated value(s) 110 to evaluate how well the individual output(s) of the student model 104 align with the preferred output(s) of the teacher model 108.

Another component of a multiscale refinement objective can be based on the reinforcement learning signal(s) 114. For example, the training system(s) 116 can evaluate a received reward or cost indicated by the reinforcement learning signal(s) 114 to determine a loss.

Based on the multiscale refinement objective, the training system(s) 116 can generate or otherwise output one or more model update(s) 118. The model update(s) 118 can include updates to one or more parameters of the student model 104. For example, the model update(s) 118 can include updating one or more parameters of the student model 104 to optimize a value of an objective that includes the multiscale refinement objective. In this manner, for instance, the training system 116 can perform efficient model distillation and reinforcement learning based on student-generated values 104 generated from the same input data 102.

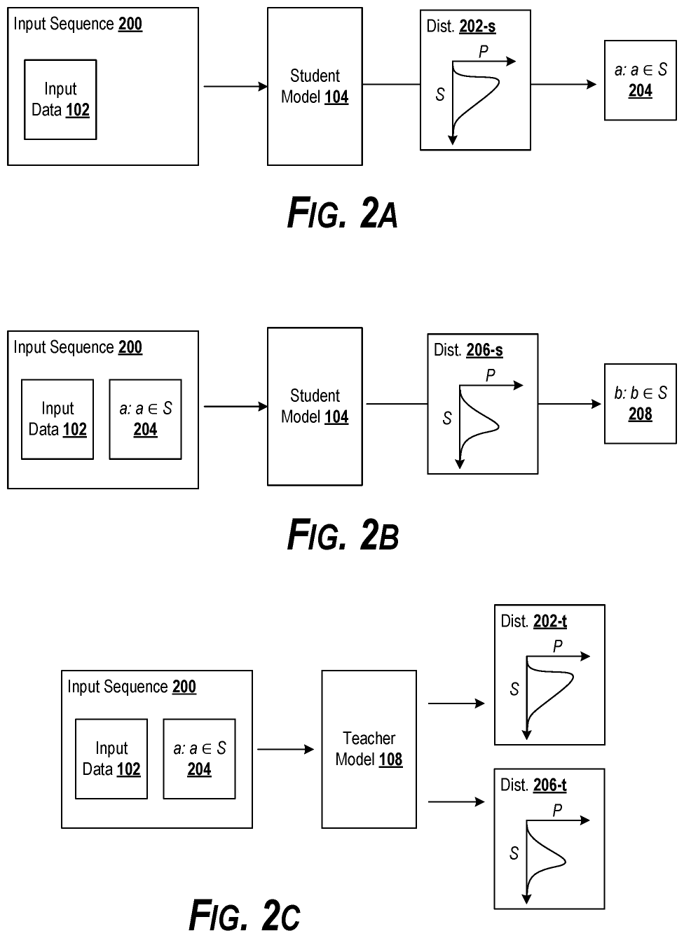

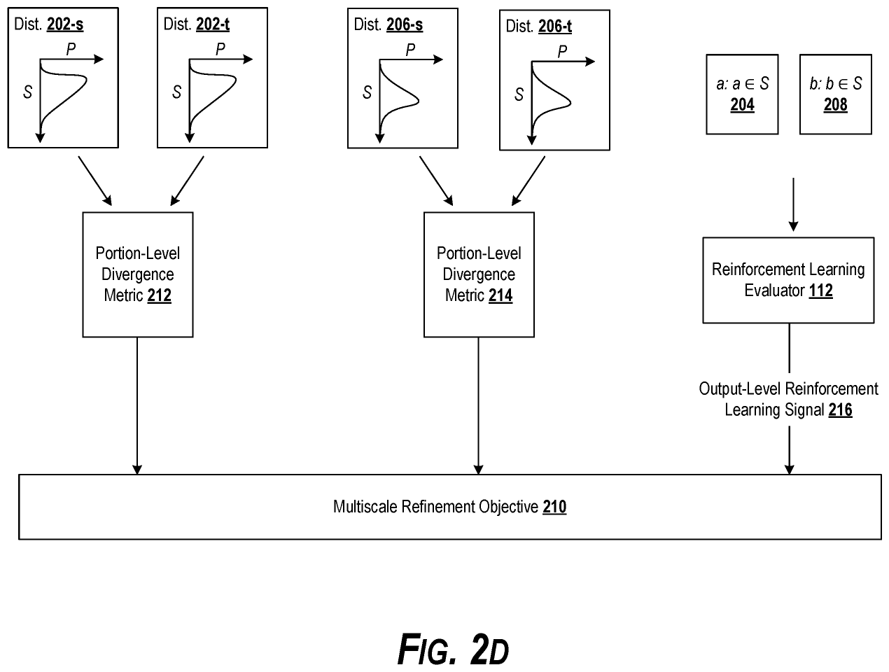

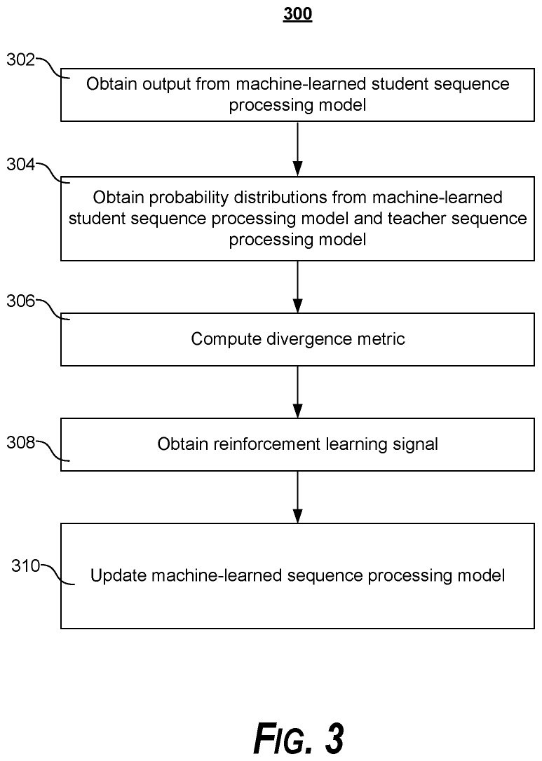

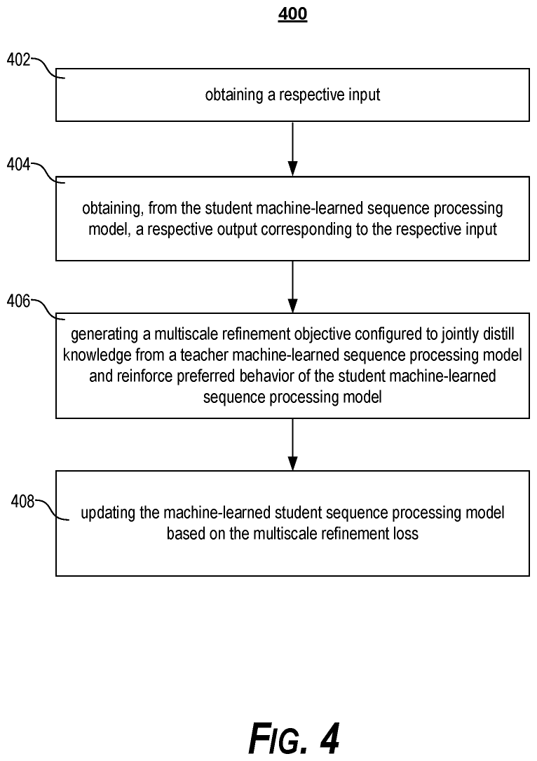

FIGS. 2A to 2D are block diagrams of an example system for performing joint distillation and reinforcement learning for autoregressive sequence processing models. For example, the student model 104 can be an autoregressive sequence processing model. The teacher model 108 can be an autoregressive sequence processing model.

In a first iteration, shown in FIG. 2A, an input sequence 200 can include input data 102. The student model 104 can process the input sequence 200 and generate a student distribution 202-s of values. Based on the student distribution 202-s, an output value 204 can be obtained.

In a second iteration, shown in FIG. 2B, the input sequence 200 can include input data 102 and the previously-generated portion, the output value 204. The student model 104 can process the updated input sequence 200, including the input data 102 and the output value 204, to generate a student distribution 206-s. Based on student distribution 206-s, an output value 208 can be obtained.

With reference to FIG. 2C, the teacher model 108 can process the full input sequence 200. The teacher model 108 can generate teacher distribution 202-t and teacher distribution 206-t to provide points of comparison for the student distributions 202-s and 206-s.

Input sequence 200 can provide context for one or more predictions by student model 104 or teacher model 108. For instance, one or more predictions by student model 104 or teacher model 108 can be conditioned on context data in input sequence 200. Input sequence 200 can include the input data 102. The input sequence 200 can be iteratively updated with generated outputs from the student model 104. In this manner, for example, across multiple iterations, the student model 104 can process, as context, its prior outputs, thereby generating new outputs conditioned on the prior outputs. In this manner, for example, the student model 104 can autoregressively generate multiple output values to form an output sequence.

The student distribution 202-s can reflect internal decision-making of the student model 104 regarding input sequence 200. For instance, the student distribution 202-s can indicate probability values associated with one or more possible output values of the student model 104 conditioned on input data 102. For example, a student model 104 can be configured to generate an output selected from a set of candidate outputs. The selected output can be selected based on the student distribution 202-s.

For example, the student distribution 202-s can indicate a score or value generated by the student model 104 that indicates a goodness of a given output candidate with respect to the input sequence 200. The student distribution 202-s can reflect a relative evaluation of the output candidates, such that a particular candidate can be selected by comparison with the values or scores for the other candidates.

Although various examples are described herein in which the teacher model 108 processes output(s) generated by the student model 104 for correcting the student model 104 (e.g., “on policy” training), it is to be understood that in some instances the student model 104 can process output(s) generated by the teacher model 108 (e.g., “off policy” training “supervised” by the teacher model 108). In some instances, training of the student model 104 can proceed using a mixture of on policy and off policy training examples. In some instances, a randomly sampled indicator value can be used to determine whether to use an on policy example or an off policy example (e.g., based on a relationship between the indicator value and a threshold, such as to use an on policy example if the randomly sampled value is above a threshold).

In some instances, the student distribution 202-s can correspond to a discrete probability distribution or continuous distribution (e.g., a probability distribution function). In some instances, the student distribution 202-s can have a plurality of subdivisions. In some instances, the subdivisions can correspond to a plurality of members of an output vocabulary of the student model 104. In some instances, the student distribution 202-s can include one or more values (e.g., probability values). In some instances, a respective value of the student distribution 202-s can include or correspond to a respective prediction (e.g., next token prediction, masked language prediction, expected output prediction). Thus, in some instances, the student distribution 202-s can be a discrete probability distribution characterized by a plurality of probability values (e.g., predictions) associated respectively with a plurality of vocabulary words.

For example, the student distribution 202-s can be a probability distribution P over an output space S. The probability values P can be generated by the student model 104. The probability values P can be generated by the student model 104 based on the input sequence 200. The probability value for a particular value s E S can indicate a likelihood of the value s based on the input sequence 200. The probability value for a particular value s E S can indicate a likelihood of the value s follows the input sequence 200 in a combined sequence (e.g., a context window).

The output value 204 can be a value generated by the student model 104. The output value 204 can be selected from a set of candidate output values based on the student distribution 202-s. The output value 204 can be, include, or otherwise represent various types of data, such as a type of data the same as or different from data represented by the input data 102.

In this manner, for instance, the student distribution 202-s can indicate predictions associated with one or more possible output values, such that the student distribution 202-s can correspond to the student model 104's reasoning over the potential outputs and an evaluation of the goodness of the outputs. While output value 204 can indicate a selected choice, other predictions (e.g., generated values) associated with other candidates can reveal other information about the student model 104's internal reasoning.

The student distribution 206-s can reflect internal decision-making of the student model 104 regarding input sequence 200. For instance, the student distribution 206-s can indicate probability values associated with one or more possible output values of the student model 104 conditioned on input data 102 and output value 204. For example, a student model 104 can be configured to generate an output selected from a set of candidate outputs. The selected output can be selected based on the student distribution 202-s.

For example, the student distribution 206-s can indicate a score or value generated by the student model 104 that indicates a goodness of a given output candidate with respect to the input sequence 200. The student distribution 206-s can reflect a relative evaluation of the output candidates, such that a particular candidate can be selected by comparison with the values or scores for the other candidates.

In some instances, the student distribution 206-s can correspond to a discrete probability distribution or continuous distribution (e.g., a probability distribution function). In some instances, the student distribution 206-s can have a plurality of subdivisions. In some instances, the subdivisions can correspond to a plurality of members of an output vocabulary of the student model 104. In some instances, the student distribution 206-s can include one or more values (e.g., probability values). In some instances, a respective value of the student distribution 206-s can include or correspond to a respective prediction (e.g., next token prediction, masked language prediction, expected output prediction). Thus, in some instances, the student distribution 206-s can be a discrete probability distribution characterized by a plurality of probability values (e.g., predictions) associated respectively with a plurality of vocabulary words.

For example, the student distribution 206-s can be a probability distribution P over an output space S. The probability values P can be generated by the student model 104. The probability values P can be generated by the student model 104 based on the input sequence 200. The probability value for a particular value s E S can indicate a likelihood of the value s based on the input sequence 200. The probability value for a particular value s E S can indicate a likelihood of the value s following the input sequence 200 in a combined sequence (e.g., a context window).

The output value 208 can be a value generated by the student model 104. The output value 208 can be selected from a set of candidate output values based on the student distribution 206-s. The output value 208 can be, include, or otherwise represent various types of data, such as a type of data the same as or different from data represented by the input data 102 and output value 204.

In this manner, for instance, the student distribution 206-s can indicate predictions associated with one or more possible output values, such that the student distribution 206-s can correspond to the student model 104's reasoning over the potential outputs and an evaluation of the goodness of the outputs with respect to input data 102 and output value 204. While output value 208 can indicate a selected choice, other predictions (e.g., generated values) associated with other candidates can reveal other information about the student model 104's internal reasoning.

Similarly, the teacher distribution 202-t can be a distribution generated based on input data 102. In this manner, for example, teacher distribution 202-t can represent the reasoning of the teacher model 108 in view of the same information available to the student model 104 when generating the student distribution 202-s. In this manner, for example, the teacher distribution 202-t can directly correspond to or otherwise provide a reference point of comparison for the student distribution 202-s.

The teacher distribution 206-t can be a distribution generated based on input data 102 and output value 204. In this manner, for example, teacher distribution 206-t can represent the reasoning of the teacher model 108 in view of the same information available to the student model 104 when generating the student distribution 206-s. In this manner, for example, the teacher distribution 206-t can directly correspond to or otherwise provide a reference point of comparison for the student distribution 206-s.

In some implementations, the teacher distribution(s) can be generated with a lower temperature setting as compared to a temperature setting used to generate the student distribution(s). For instance, a temperature parameter can affect a shape of the distribution. For example, the probability of predicting nth token y_n, p(y_n|x), can be determined using a softmax with temperature gamma:

$$p ( {y}_{n} \vert x ) = \frac{exp ( {𝓏}_{n} / γ )}{{\sum }_{i = 1}^{M} exp ( {𝓏}_{i} / γ )} ,$$

where z_n can be a logit score for a token y_n. Greedy sampling can correspond to a temperature of zero. Temperature sampling can correspond to a nonzero temperature.

Any one or more of the student or teacher distributions can be partial or complete distributions. For example, in some situations a full distribution over all the output space might not be known. For example, a top-K set of output values and their corresponding probabilities might be known. The distribution can be based on the top-K set. K can be 1 or more than 1.

Advantageously, the teacher model 108 can generate teacher distributions 202-t and 206-t in parallel. The teacher model 108 can generate teacher distributions 202-t and 206-t b re-using one or more computations. For example, the teacher model 108 can generate teacher distributions 202-t and 206-t without performing multiple forward inference passes. For example, a teacher model 108 can compute one or more matrices that store or encode meanings of, and relationships between, the input sequence 200 (e.g., a KV cache of a transformer model). The teacher model 108 can use such values to compute both the teacher distributions 202-t and 206-t. Further, by processing an input sequence 200 already generated by the student model 104, the teacher model 108 can generate output distribution(s) without itself autoregressively generating output values.

In this manner, for example, example implementations of the present disclosure can decrease or avoid a computational cost of obtaining feedback from a teacher model 108 (e.g., which can be computationally more expensive to execute than the student model 104).

Portion-level divergence metrics 212 and 214 can indicate a difference or similarity between the distributions for a given set of portions of input(s). For example, student distribution 202-s and teacher distribution 202-t can be generated based on one or more portions of a sequence that precede output value 204. In this manner, for instance, student distribution 202-s and teacher distribution 202-t can be evaluated to obtain a portion-level divergence metric 212 that evaluates an alignment of distribution(s) generated for those portions that precede output value 204. Similarly, student distribution 206-s and teacher distribution 206-t can be generated based on one or more portions of a sequence that precede output value 208. In this manner, for instance, student distribution 206-s and teacher distribution 206-t can be evaluated to obtain a portion-level divergence metric 214 that evaluates an alignment of distribution(s) generated for those portions that precede output value 208.

Portion-level divergence metrics 212 and 214 can be combined or aggregated to determine an overall divergence metric. Portion-level divergence metrics 212 and 214 can be summed. Portion-level divergence metrics 212 and 214 can be averaged (e.g., a weighted average). Other aggregation techniques can be used.

Portion-level divergence metrics 212 and 214 can be combined by aggregating the divergences of the distributions at the respective inference steps. For instance, each prediction step can be associated with a probability distribution from the student model and a probability distribution from the teacher model. An aggregate divergence can include combining divergences from each inference step. An aggregate divergence can include averaging divergences from each inference step. An example aggregate divergence can be described as follows:

$$𝒟 ( {p}_{T} ‖ {p}_{S}^{θ} ) ( y \vert x ) := \frac{1}{{L}_{y}} {\sum }_{n = 1}^{{L}_{y}} 𝒟 ( {p}_{T} ( \cdot \vert {y}_{< n} , x ) ‖ {p}_{S}^{θ} ( \cdot \vert {y}_{< n} , x ) ) ,$$

for an input sequence x and an output sequence y, where L_y is the length of a sequence y (e.g., a number of inference steps), P_T is a teacher probability distribution for a next portion of y, P_S is a student probability distribution for a next portion of y.

Portion-level divergence metrics 212 and 214 can be computed based on individual values from the distributions (e.g., values drawn from discrete distributions) that are generated based on one or more portions of the inputs. For example, a student value can be drawn from the student distribution and a teacher value can be drawn from the teacher distribution. These values can be compared and the comparisons aggregated over the distribution(s) to compute a total divergence value for the pair of distributions.

An example divergence metric uses a ratio of the student value and the teacher values. In some instances, computing the ratio can include dividing the reference value by the student value. In some instances, an asymmetric (e.g. non-commutative, directional) divergence metric (e.g. Kullback-Leibler divergence) can be computed using an asymmetric (e.g. non-commutative) function of the value and reference value.

In some instances, the divergence metric can be computed by summing a plurality of comparison values across a plurality of subdivisions of the probability distribution. In some instances, computing a respective comparison value can include multiplying a log of a respective ratio by a respective reference value associated with the respective ratio.

In some instances, the divergence metric can include a metric that induces mode-seeking behavior when used in an objective function (e.g. a divergence metric wherein minimizing the divergence metric between a learned probability distribution and a teacher probability distribution would cause a learned probability value to be zero whenever a corresponding reference probability value is zero). In some instances, the divergence metric can correspond to a Kullback-Leibler divergence, a Jensen-Shannon divergence, a modified Kullback-Leibler divergence, or a modified Jensen-Shannon divergence. In some instances, a Kullback-Leibler divergence can be computed in either direction (e.g. from a reference distribution to a student distribution, or from a student distribution to a reference distribution). In some instances, the Kullback-Leibler divergence can be computed in a direction that induces mode-seeking behavior when used in an objective function. In some instances, this direction can be called “reverse KL,” and computing a “reverse KL” metric can include computing a sum over a vocabulary of (student probability value*log (student probability value divided by teacher probability value)), wherein a respective teacher probability value can be a probability value (e.g. a next-token prediction probability) associated with a token/vocabulary word in a teacher vocabulary, and a respective student probability value can be associated with a similar (e.g. same) token/vocabulary word in a student vocabulary that can be similar to (e.g. overlap with, be the same as) the teacher vocabulary.

In some instances, computing the first divergence can include summing a plurality of comparison values across a plurality of subdivisions or bins of a distribution. In some instances, a comparison value can include or correspond to a ratio between a respective student probability value and a respective teacher probability value associated with a respective subdivision (e.g. log (student value/teacher value)). In some instances, a respective subdivision can be associated with a respective output candidate in an output space of the student model 104. In some instances, the first divergence can correspond to a Kullback-Leibler divergence or modified Kullback-Leibler divergence. In some instances, the first divergence can correspond to a Kullback-Leibler divergence from the student distribution to the mixture ratio. An example KL divergence can be described as follows,

$${𝒟}_{KL} ( P ‖ Q ) = {\sum }_{c ∈ 𝒞} P ( c ) log \frac{P ( c )}{Q ( c )}$$

where P and Q are respective discrete distributions with C bins.

In some instances, a mixture-based divergence metric (e.g., Jensen-Shannon) can interpolate between mode-seeking and mean-seeking divergence metrics. For example, aligning a student distribution to a teacher distribution based on a mode-seeking divergence metric can cause the student distribution to learn to assign probability mass broadly over the output space, even for areas of the output space that might have low probability under the teacher distribution. This can increase a diversity of the output of the student model. However, for student models with relatively limited expressivity (as compared to the teacher model), a mode-seeking divergence can help the student model focus its expressivity on a narrower range of the output space around a mode of the teacher probability distribution. This can increase aspects of correctness of the student model by prioritizing alignment with higher-probability regions of the teacher distribution. However, focusing on a narrower range of the output space can decrease output diversity.

By allowing interpolation between mode-seeking and mean-seeking divergence metrics, a mixture-based divergence metric can allow for optimization of a diversity-performance tradeoff for various tasks. For example, creative tasks might prioritize diversity, so training a student model to be more creative can use a divergence metric configured to provide more mean-seeking behavior. Other tasks (e.g., data retrieval, generating tool calls for tool use, etc.) might benefit from higher accuracy or precisions, so training such a student model can use a divergence metric configured to provide more mode-seeking behavior. In general, the balance of mode- and mean-seeking behavior can be optimized in training for various tasks. For example, a learnable hyperparameter can control such interpolation. Advantageously, a reinforcement learning signal can provide an independent training signal that can be used to help optimize the interpolation.

Computing a mixture-based divergence metric can include determining a mixture distribution and computing a first divergence between a student distribution and the mixture distribution. Computing the divergence metric can include computing a second divergence between a teacher distribution and the mixture distribution. Computing the divergence metric can include combining the first and second divergence. In some instances, the mixture distribution can correspond to a mixture of a student probability distribution and a teacher probability distribution. An example mixture-based divergence metric can be described as follows:

$${𝒟}_{JSD ( β )} ( P ‖ Q ) = β {𝒟}_{KL} ( P ‖ β P + ( 1 - β ) Q ) + ( 1 \to β ) {𝒟}_{KL} ( Q ‖ β P + ( 1 - β ) Q )$$

where beta indicates an interpolation parameter (e.g., which can be a learnable hyperparameter).

In some instances, the mixture distribution can be obtained by interpolating between a student distribution and a teacher distribution based on a weight (e.g., 0.1, 0.9, 0.5 etc.). In some instances, the mixture distribution can correspond to a weighted combination of a student distribution and a teacher distribution (e.g. 0.1*student+0.9*reference). In some instances, the weight can be a hyperparameter that can be learned during training.

In some instances, evaluating a divergence metric based on the first divergence and second divergence can include computing a weighted combination of the first divergence and the second divergence. In some instances, the weight can be a hyperparameter that can be learned during training. In some instances, the weight used here can be the weight used to generate the mixture distribution. As an illustrative example, in some instances corresponding to a weight of 0.1, a mixture distribution can correspond to 0.1*student distribution 222+(1−0.1)*teacher distribution 224, and a weighted combination of divergences can correspond to (1−0.1)*first divergence+0.1*second divergence.

Output-level reinforcement learning signal 220 can be generated by reinforcement learning evaluator 112 based on human feedback (e.g., RLHF). Output-level reinforcement learning signal 220 can be generated by reinforcement learning evaluator 112 based on an output of a machine-learned model (e.g., RLAIF).

Multiscale refinement objective 222 can be based on a combination of the divergence metric(s) and the reinforcement learning signal(s). The combination can be weighted using a weighting parameter. An example expression of the multiscale refinement objective 222 can be as follows:

$${𝔼}_{x ∼ X} [ ( 1 - α ) {E}_{y \sim {p}_{S}^{θ} ( \cdot \vert x )} [ r ( y ) ] - α {𝔼}_{y \sim {p}_{S} ( \cdot \vert x )} [ 𝒟 ( {p}_{T} ‖ {p}_{S}^{θ} ) ( y \vert x ) ] ] ,$$

where α∈[0, 1] controls the strength of the distillation loss compared to the RL objective. In some implementations, a multiscale refinement objective 222 can facilitate maximizing a reward or other performance metric while directly updating more granular reasoning capabilities via distillation.

### Example Methods

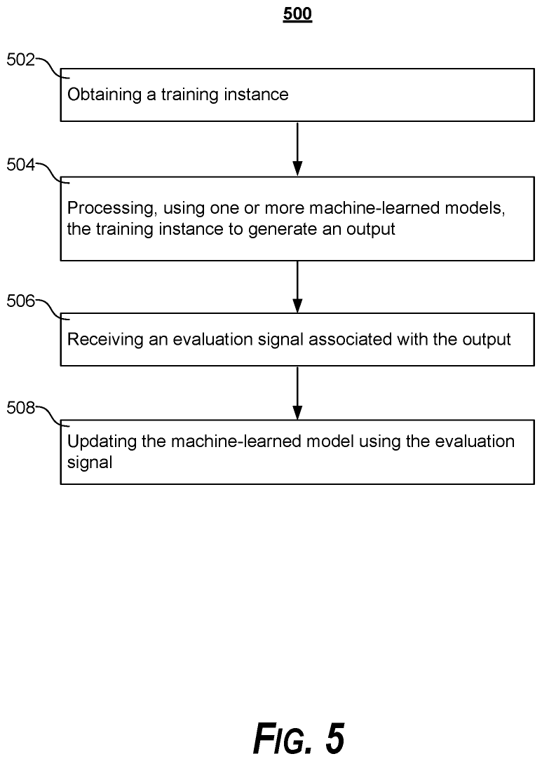

FIG. 3 depicts a flowchart diagram of an example method 300 for distilling a machine-learned model from a reference model according to example embodiments of the present disclosure. Example method 300 can be implemented by one or more computing systems (e.g., one or more computing systems as discussed with respect to FIGS. 1 to 15). Although FIG. 3 depicts steps performed in a particular order for purposes of illustration and discussion, the methods of the present disclosure are not limited to the particularly illustrated order or arrangement. The various steps of example method 300 can be omitted, rearranged, combined, and/or adapted in various ways without deviating from the scope of the present disclosure.

In some instances, at 302 method 300 can include obtaining an output from a machine-learned student sequence processing model. The output can include, for example, an output value 204, 208.

In some instances, at 304 method 300 can include obtaining a student probability distribution from a student machine-learned sequence processing model (e.g., a student model 104) and a teacher probability distribution from a teacher machine-learned sequence processing model (e.g., a teacher model 108). The teacher probability distribution can be, for example, a teacher distribution 202-t or 206-t. The first probability distribution can be, for example, a student probability distribution 202-s, 206-s.

In some instances, at 306 method 300 can include computing a divergence metric. In some instances, step 306 can be performed by a training system(s) 116. In some instances, the divergence metric can be, for instance, portion-level divergence metric 212 or 214.

In some instances, at 308 method 300 can include obtaining a reinforcement learning signal. In some instances, the reinforcement learning signal can be a reinforcement learning signal 114, 216.

In some instances, at 310 method 300 can include updating the first machine-learned sequence processing model. In some instances, step 310 can include a training system(s) 116 performing a model update 118 on a student model 104. In some instances, step 310 can include updating the first machine-learned sequence processing model based on an objective function (e.g. performing a gradient update to optimize an objective function). In some instances, step 310 can be performed without backpropagating through the output generation process of step 302. In some instances, the objective function can include multiscale refinement objective 222.

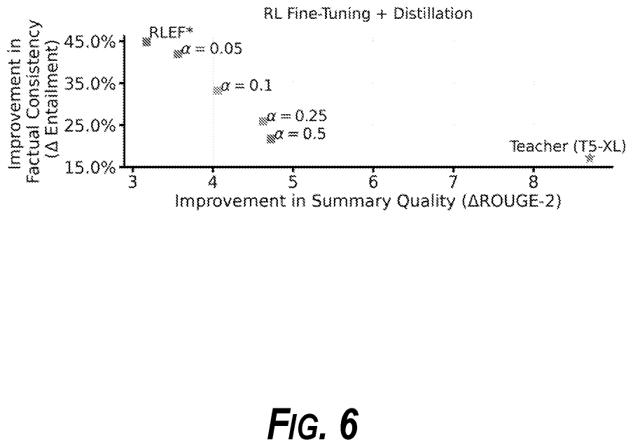

FIG. 4 depicts a flowchart diagram of an example method 400 for joint distillation and reinforcement learning according to example embodiments of the present disclosure. Example method 400 can be implemented by one or more computing systems (e.g., one or more computing systems as discussed with respect to FIGS. 1 to 15). Although FIG. 4 depicts steps performed in a particular order for purposes of illustration and discussion, the methods of the present disclosure are not limited to the particularly illustrated order or arrangement. The various steps of example method 400 can be omitted, rearranged, combined, and/or adapted in various ways without deviating from the scope of the present disclosure.

In some instances, at 402 example method 400 can include obtaining a respective input. The input can include input sequence 200.

In some instances, at 404 example method 400 can include obtaining, from the student machine-learned sequence processing model, a respective output corresponding to the respective input. The respective output can include an output value 204, 208.

In some instances, at 406 example method 400 can include generating a multiscale refinement objective configured to jointly distill knowledge from a teacher machine-learned sequence processing model and reinforce preferred behavior of the student machine-learned sequence processing model. In some instances, the multiscale refinement objective can include a first component based on a divergence metric characterizing a comparison of a plurality of predictions of the student machine-learned sequence processing model to a plurality of predictions of the teacher machine-learned sequence processing model (e.g., a student distribution); and a second component based on a reinforcement learning signal associated with the respective output.

In some instances, at 408 example method 400 can include updating the machine-learned student sequence processing model based on the multiscale refinement objective.

In some implementations of example method 400, the divergence metric is evaluated using a student value generated by the machine-learned student sequence processing model for one or more portions of the respective output based on the respective input. For instance, the student value can correspond to a student probability of the one or more portions of the respective output conditioned on the respective input. An example student probability can be a member of a distribution of probabilities output by the machine-learned student sequence processing model. The distribution of probabilities can be, for example, a student distribution 202-s, 206-s, etc.

In some implementations of example method 400, the divergence metric is evaluated using a teacher value generated by the machine-learned teacher sequence processing model for the one or more portions of the respective output based on the respective input. For instance, the teacher value can correspond to a teacher probability of the one or more portions of the respective output conditioned on the respective input. An example teacher probability can be a member of a distribution of probabilities output by the machine-learned teacher sequence processing model. The distribution of probabilities can be, for example, a teacher distribution 202-t, 206-t, etc.

Example method 400 can include, for each portion of a plurality of portions of the respective output, determining a portion-specific divergence metric. The portion-specific divergence metric can characterize a similarity between a student probability distribution over a set of candidate output portions and a teacher probability distribution over the set of candidate output portions. The portion-specific divergence metric can be specific to the portion because each of the student probability distribution and the teacher probability distribution can be conditioned on the respective input and one or more portions of the respective output that precede that specific portion. Example method 400 can include aggregating the plurality of portion-specific divergence metrics for the respective output to obtain the first component.

In some implementations of example method 400, the teacher probability distributions for each of the portion-specific divergence metrics are generated at least partially in parallel by the machine-learned teacher sequence processing model. For instance, because the machine-learned teacher sequence processing model can process the sequence already generated by the machine-learned student processing model to generate distributions, the machine-learned teacher sequence processing model can avoid autoregressively (e.g., sequentially) generating its own output sequence.

In some implementations of example method 400, the objective includes one or more weighting parameters that weight the respective contributions of the first component and the second component of the multiscale refinement objective. In this manner, for instance, a strength of the distillation can be adjusted with respect to a strength of the reinforcement learning signal. In this manner, for instance, the training can prioritize granular “correctness” with overall output “goodness.”

In some implementations of example method 400, the reinforcement learning signal includes data indicating human feedback on an overall quality of the respective output. The human feedback can be received via one or more user interfaces. The human feedback can be received in real time with generation of the output(s) using the machine-learned student sequence processing model (e.g., responsive to a client system receiving output(s) generated using the machine-learned student sequence processing model).

In some implementations of example method 400, the reinforcement learning signal includes data indicating a score generated by a machine-learned reward model, wherein the score indicates an overall quality of the respective output. For example, a machine-learned reward model can evaluate an overall quality of output(s) generated using the machine-learned student sequence processing model, such as whether the output(s) answer a question, perform a requested task, contain requested information, advance a state of a multi-sequence process, etc.

In some implementations of example method 400, evaluating the divergence metric includes determining a value of a mixture distribution corresponding to a mixture of a student probability distribution of the machine-learned student sequence processing model and a teacher probability distribution of the machine-learned teacher sequence processing model. In some implementations of example method 400, evaluating the divergence metric includes computing a first divergence component that characterizes a divergence of the student probability distribution with respect to the mixture distribution. In some implementations of example method 400, evaluating the divergence metric includes computing a second divergence component that characterizes a divergence of the teacher probability distribution with respect to the mixture distribution. In some implementations of example method 400, evaluating the divergence metric includes evaluating the divergence metric based on a combination of the first divergence component and the second divergence component. For instance, a divergence metric based on a mixture distribution can be a Jensen-Shannon divergence.

In some implementations of example method 400, evaluating the divergence metric based on the first divergence component and the second divergence component can include computing, using a weighting parameter, a weighted combination of the first divergence component and the second divergence component. In some implementations of example method 400, adjusting the weighting parameter causes the divergence metric to interpolate between a mode-seeking behavior and a mean-seeking behavior. Example method 400 can include, for instance, adjusting the weighting parameter based on a desired output diversity for a type of task. In some implementations of example method 400, the weight is a learned hyperparameter during training.

In some implementations of example method 400, the machine-learned teacher sequence processing model was not trained using reinforcement learning. For instance, an ultimate objective (e.g., outputs that increase a reward) can be applied to the student model directly, such as in lieu of first training the teacher model to increase the reward (potentially at significant expense). Even if the teacher model is first trained to increase the reward, in some situations distillation alone from the teacher can be inadequate to obtain a student model that optimally increases the reward.

In some implementations of example method 400, the machine-learned student sequence processing model was fine-tuned to achieve a baseline threshold of performance before training with the multiscale refinement objective.

In some implementations of example method 400, the machine-learned student sequence processing model is characterized by a first number of parameters, the machine-learned teacher sequence processing model is characterized by a second number of parameters, and the second number of parameters is larger than the first number of parameters. For example, the second number of parameters can be at least 30 times the first number of parameters.

Example method 400 can include receiving, from a client computing system, a request to perform an inference task based on input data. For instance, a host computing system can provide a machine learning service which serves inference(s) (or outputs based thereon) in response to client requests. A client request can include some input data for which a corresponding output is desired. Example method 400 can include obtaining the respective input from the input data. Example method 400 can include generating the respective output using the machine-learned student sequence processing model to process the input data. Example method 400 can include returning, to the client computing system and responsive to the request, output data based on the respective output. Example method 400 can include receiving, from the client computing system, feedback data. For example, a host computing system can receive approval of, rejection of, edits to, or other feedback associated with the provided output data. Example method 400 can include determining the reinforcement learning signal based on the feedback data.

Example method 400 can include, in an online process, receiving the request and returning the output data. Example method 400 can include, in an offline process, obtaining the plurality of predictions of the teacher machine-learned sequence processing model and updating the machine-learned student sequence processing model based on the multiscale refinement objective.

An example method for determining a divergence metric can include determining a mixture distribution. In some instances, the mixture distribution can correspond to a mixture of a teacher probability distribution (e.g., teacher distribution 202-t, 206-t) and a student probability distribution (e.g., student distribution 202-s, 206-s). In some instances, the mixture distribution can be obtained by interpolating between the reference probability distribution and the student probability distribution based on a weight (e.g. 0.1, 0.9, 0.5 etc.). In some instances, the mixture distribution can correspond to a weighted combination of the reference probability distribution and the student probability distribution (e.g. 0.1*student+0.9*reference). In some instances, the weight can be a hyperparameter that can be learned during training.

An example method for determining a divergence metric can include computing a first divergence between a student distribution and the mixture distribution. In some instances, computing the first divergence can include summing a plurality of comparison values across a plurality of subdivisions of the probability distribution. In some instances, a comparison value can include or correspond to a ratio between a respective student probability value and a respective mixture probability value associated with a respective subdivision (e.g. log (student value/mixture value)). In some instances, a respective subdivision can be associated with a respective token in a vocabulary of the student model 104. In some instances, the first divergence can correspond to a Kullback-Leibler divergence or modified Kullback-Leibler divergence. In some instances, the first divergence can correspond to a Kullback-Leibler divergence from the student distribution to the mixture ratio.

An example method for determining a divergence metric can include computing a second divergence between a teacher distribution and the mixture distribution. In some instances, computing the second divergence can include summing a plurality of comparison values across a plurality of subdivisions of the probability distribution. In some instances, a comparison value can include or correspond to a ratio between a respective teacher probability value and a respective mixture probability value associated with a respective subdivision (e.g. log (teacher value/mixture value)). In some instances, a respective subdivision can be associated with a respective token in a vocabulary of the teacher model 210. In some instances, the second divergence can correspond to a Kullback-Leibler divergence or modified Kullback-Leibler divergence. In some instances, the first divergence can correspond to a Kullback-Leibler divergence from the teacher distribution to the mixture ratio.

An example method for determining a divergence metric can include evaluating a divergence metric based on the first divergence and second divergence. In some instances, step 408 can include computing a weighted combination of the first divergence and the second divergence. The weighted combination can be a JSD metric. In some instances, the weight can be a hyperparameter that can be learned during training. In some instances, the weight used in step 408 can be the weight used in step 402. As an illustrative example, in some instances corresponding to a weight of 0.1, a mixture distribution can correspond to 0.1*student distribution+(1−0.1)*teacher distribution, and a weighted combination of divergences can correspond to (1−0.1)*first divergence+0.1*second divergence.

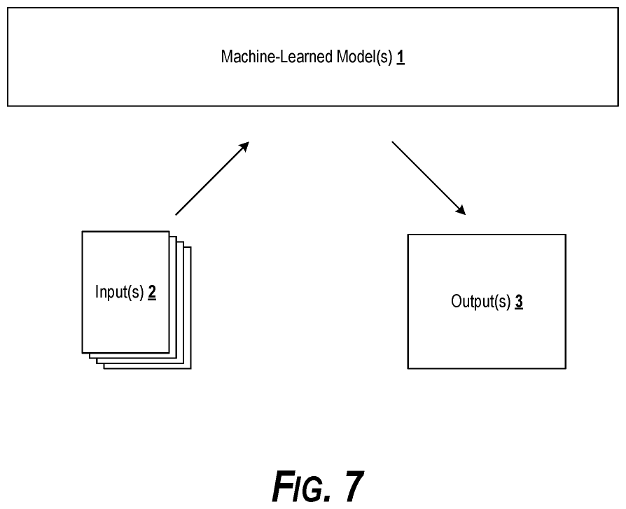

FIG. 5 depicts a flowchart of a method 500 for training one or more machine-learned models according to aspects of the present disclosure. For instance, an example machine-learned model can include a student model 104.

One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 500 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types. In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Results

FIG. 6 shows results from an example test using a multiscale refinement objective to train a student machine-learned model for a summarization task. In summarization, model-generated summaries are generally desired to be factually consistent with their input documents. However, distillation alone might not improve factual consistency, as even large models can hallucinate and generate inconsistent summaries.

FIG. 6 provides two baselines. RLEF*corresponds to a T5-base model trained with the RLAIF method from Roit et al. (2023), where the student is regularized towards the original student model itself instead of the teacher. Teacher corresponds to the T5-XL model (12× larger than T5 base).

The markers indicated with alpha values refer to example implementations of the present disclosure in which a multiscale refinement objective of the following formulation was used to jointly distill knowledge from T5-XL and train with a RLAIF reward from a textual entailment score from a T5-XXL NLI classifier with weighting parameter alpha:

$${𝔼}_{x ∼ X} [ ( 1 - α ) {E}_{y \sim {p}_{S}^{θ} ( \cdot \vert x )} [ r ( y ) ] - α {𝔼}_{y \sim {p}_{S} ( \cdot \vert x )} [ 𝒟 ( {p}_{T} ‖ {p}_{S}^{θ} ) ( y \vert x ) ] ] ,$$

where JSD was used with a 0.9 beta.

As shown in FIG. 6, joint distillation with RL fine-tuning substantially improves factual consistency compared to the much larger teacher model while obtaining large improvements in summarization quality for the distilled student model as compared to RLEF*alone.

Other example test results are discussed below.

An example training algorithm is presented in pseudocode below:

Algorithm 1 for training based on divergence loss component

| | |
|---|---|
| 1: | Given: Teacher model pT, Student Model p θ S , Dataset (X, Y) containing (input, output) |

pairs

| | |
|---|---|
| 2: | Hyperparameters: Student data fraction λ ∈ [0, 1], Divergence D, Learning rate η |
| 3: | for each step k = 1, . . . , K do |
| 4: | Generate a random value u ~ Uniform(0, 1) |
| 5: | if u ≤ λ then |
| 6: | Sample inputs x from X and generate outputs y ~ p θ S (·\|x) to obtain B = {(xb, |

yb)}B b=1

| | |
|---|---|
| 7: | else |
| 8: | Sample batch of inputs and outputs from (X, Y) to obtain B = {(xb, yb)}B b=1 . |
| 9: | end if |
| 10: | $Update θ to minimize {L}_{GKD} : θ ← θ - η \frac{1}{B} {\sum }_{( x , y ) ∈ B} {∇}_{θ} 𝒟 ( {p}_{T} ‖ {p}_{S}^{θ} ) ( y \vert x )$ |
| 11: | end for |

In some example summarization experiments according to the present disclosure, a student model 104 can be distilled according to Algorithm 1 from a teacher model 108 based on portions of one or more training examples from one or more summarization datasets (e.g. 1,000 examples, 10,000 examples, 50,000 examples, 200,000 examples, etc.). In some instances, the student model 104 can be distilled without the use of any ground-truth summaries. In some instances, a student model 104 distilled according to the present disclosure (e.g. student data fraction=1, divergence=Jensen-Shannon based on 90 percent mixture), using only 1,000 training examples and without using ground truth summaries, can outperform (e.g. achieve higher bigram-overlap scores) prior models of the same size that have been trained on 200,000 training examples, with ground truth summaries, of the same summarization dataset. An even larger improvement (e.g. 6× larger) can be possible if a student model 104 is trained according to the present disclosure on a larger number (e.g. 10,000, 50,000) of training examples.

In some example summarization experiments according to the present disclosure, student models 104 of varying sizes can be compared to same-size models trained according to other methods. In such experiments, models trained according to the present disclosure can consistently outperform same-size models trained according to other methods. In some experiments according to the present disclosure, a 77-million-parameter model distilled according to the present disclosure achieved similar performance (e.g., similar bigram-overlap score) to a 250-million-parameter model distilled according to other methods.

In some example summarization experiments according to the present disclosure, student models 104 trained according to Algorithm 1 can be compared to larger pretrained models (e.g. a 540-billion transformer model prompted with few-shot prompting). In some experiments, a 77-million-parameter student model 104 can achieve similar performance to a pretrained model having approximately 7,000 times as many parameters.

In some example summarization experiments according to the present disclosure, student models 104 can be trained according to methods described herein based on a combination of the divergence metrics of Algorithm 1 and a reinforcement learning signal. In some experiments involving summarization, the reinforcement learning signal can be a textual entailment feedback score indicating whether a student model 104 summary is entailed by the input context it is summarizing. In some instances, the student model 104 can be trained using an objective function comprising both a divergence metric and a reinforcement learning signal. In some instances, the objective function can be a weighted sum (e.g. (1 minus alpha)*(RL signal)+alpha*divergence). In some experiments, a student model 104 trained with alpha as high as 0.5 can achieve a higher entailment score than the teacher model 108 it learned from, even when the teacher model 108 is much larger (e.g. 38 times as many parameters) than the student model 104. In other experiments, a student model 104 trained with alpha as low as 0.05 can achieve much higher entailment scores than the teacher model 108 (e.g. more than 40 percent entailed vs. less than 20 percent entailed) while still achieving significant improvement in summarization quality (more than 3 point bigram-overlap score improvement) over a base model that was not distilled according to the present disclosure.

In some example experiments according to the present disclosure, various values were used as a softmax temperature of the teacher model 108. In some trials, student models 104 trained using a teacher temperature under 1.0 (e.g., under 0.5) showed significant improvement on summarization tasks (e.g. higher bigram-overlap score) over student models 104 trained with a teacher temperature of 1.0.

In some example machine translation experiments according to the present disclosure, 77-million- and 250-million-parameter student models 104 were trained according to Algorithm 1 using various mode-seeking divergence metrics (e.g., “reverse KL” Kullback-Leibler divergence, modified Jensen-Shannon divergence based on 90 percent mixture, modified Jensen-Shannon divergence based on 10 percent mixture, etc.). In such experiments, student models 104 trained according to the present disclosure performed better (e.g., higher scores on one or more machine-translation metrics based on n-gram overlap between model-generated translations and human-generated reference translations) on machine translation tasks than models distilled according to other methods.

In some example mathematical reasoning experiments according to the present disclosure, the input data 102 can include one or more few-shot prompting and/or chain-of-thought prompting exemplars adapted to mathematical reasoning. In some instances, a respective input data 102 can further include a mathematical reasoning problem from a mathematical reasoning dataset (e.g., appended to an input context immediately after a few-shot or chain-of-thought prompt). In such experiments, 250-million-parameter student models 104 trained according to the present disclosure (e.g., student data fraction=1, “reverse KL” Kullback-Leibler divergence) outperformed (e.g., higher mathematical accuracy) same-size models trained on other methods. In some example experiments, 250-million-parameter student models trained according to the present disclosure achieved performance similar to a 137-billion-parameter model (548 times larger) prompted using chain-of-thought prompting.

These and other example results are described in more detail in Agarwal et al., Generalized Knowledge Distillation for Auto-regressive Language Models, arXiv: 2306.13649v2 (Oct. 3, 2023), which is hereby incorporated by reference herein in its entirety.

### Example Machine-Learned Models

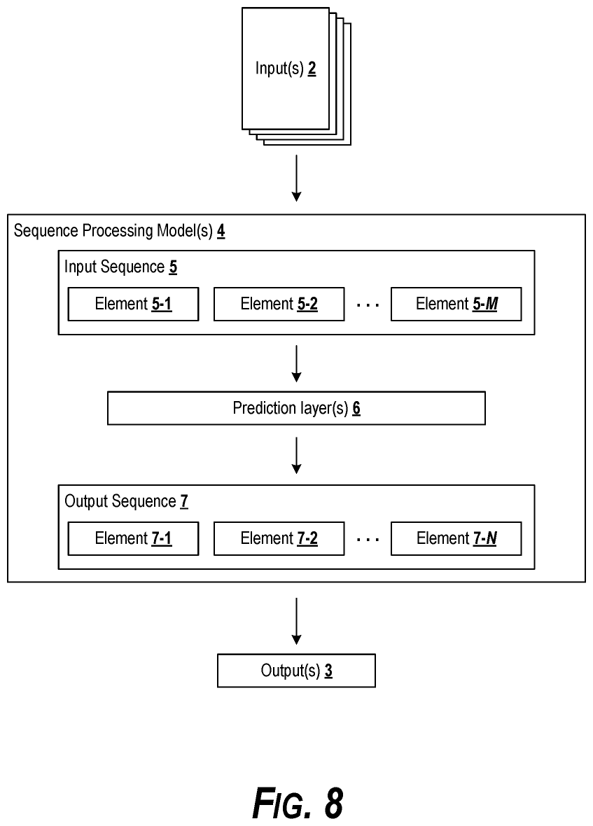

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Machine-learned model(s) 1 can be an example of a student model 104 or a teacher model 108. Various configurations of machine-learned model(s) 1 described herein are to be understood as also describing various configurations of a student model 104 or a teacher model 108.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

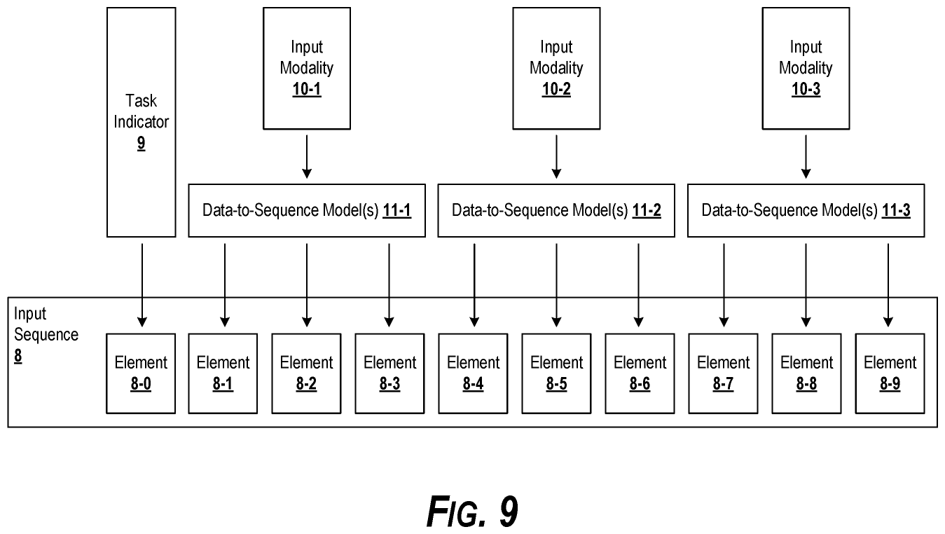

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2 . . . 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2 . . . 5-M can represent tokens obtained using a tokenizer. For instance, a tokenizer can process a given portion of an input source and output a series of tokens (e.g., corresponding to input elements 5-1, 5-2, . . . 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2 . . . 5-M depicted in FIG. 7 can be the tokens or can be the embedded representations thereof.

Prediction layer(s) 6 can predict one or more output elements 7-1, 7-2 . . . 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2 . . . 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of_.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

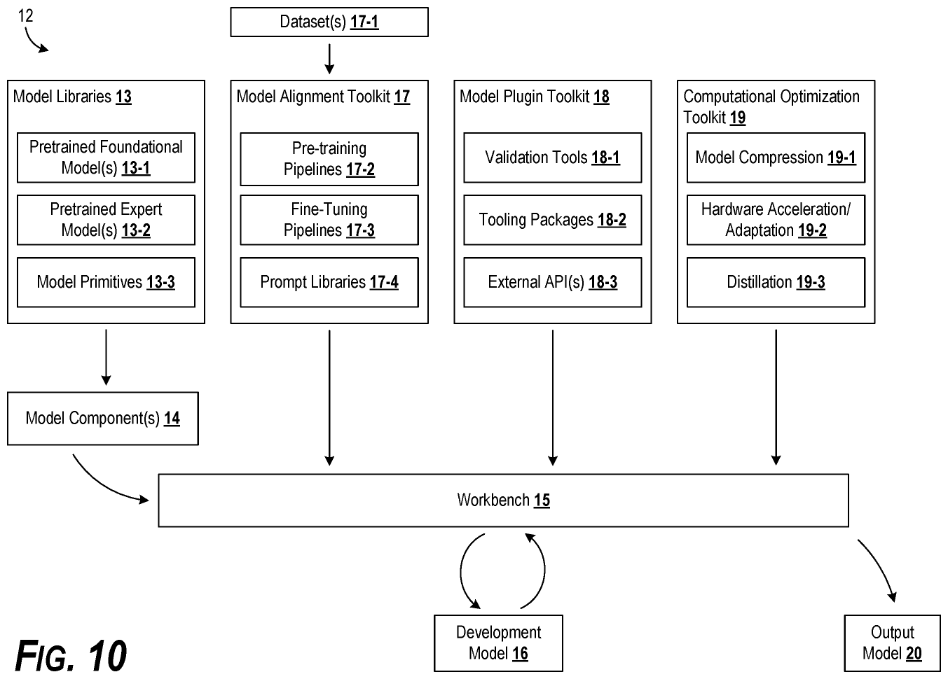

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

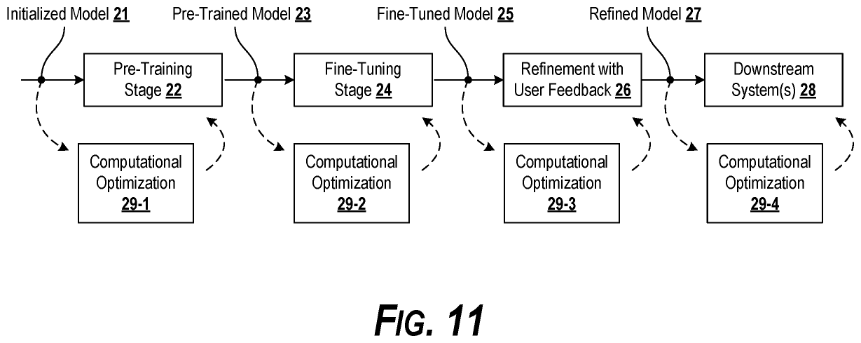

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and generate an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

Workbench 15 can implement training techniques according to the present disclosure to jointly distill (e.g., distillation 19-3) and conduct reinforcement learning (e.g., via fine-tuning pathways 17-3) using a multiscale refinement objective according to example implementations of the present disclosure.

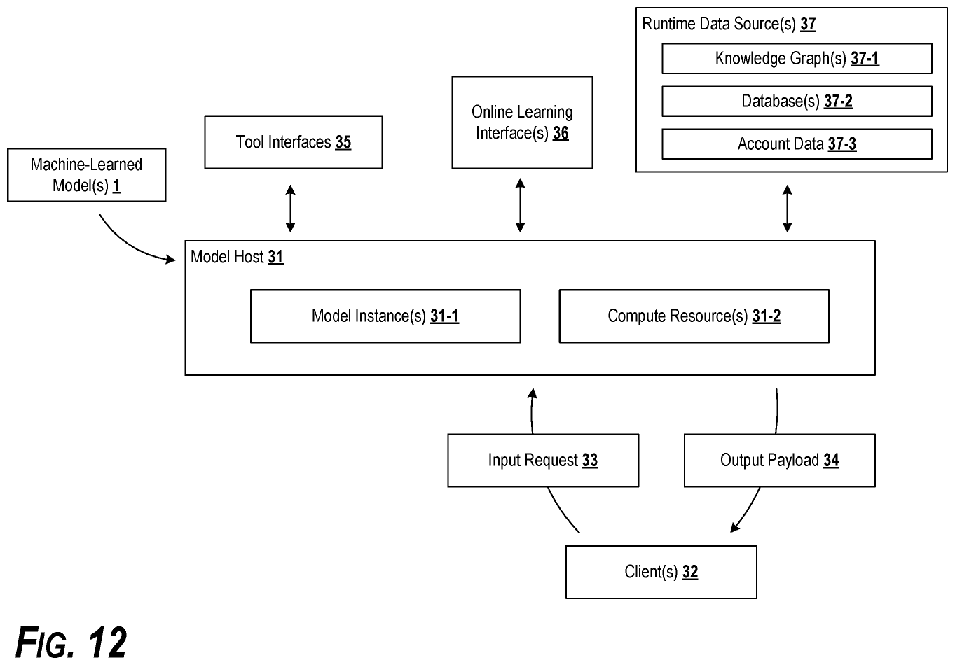

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1 . . . 29-4 can all be the same, all be different, or include at least some different optimization techniques.

### Example Machine-Learned Model Inference System

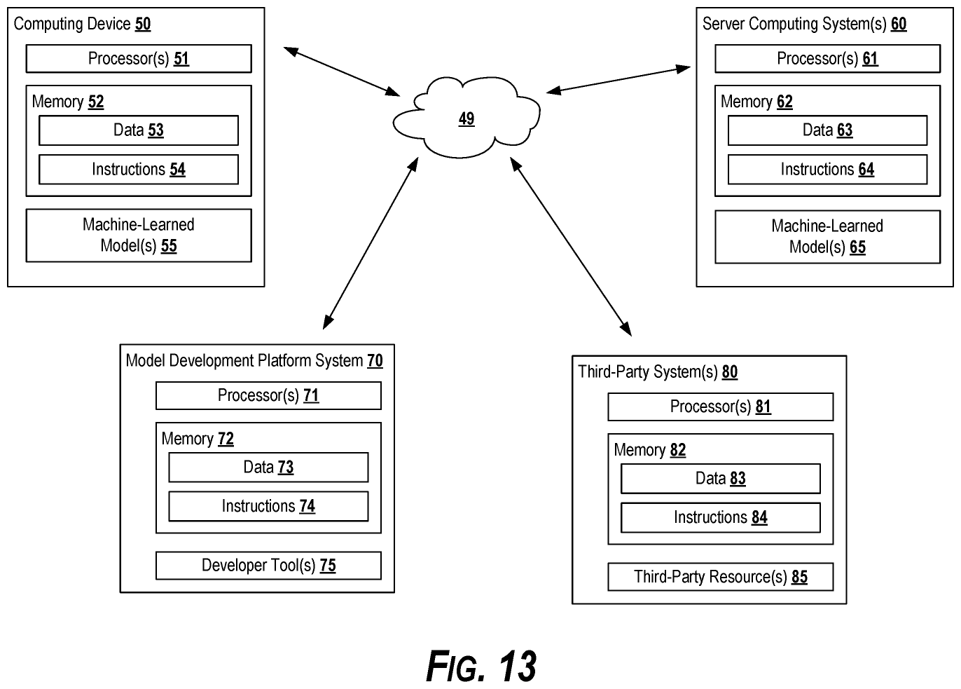

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can receive a distilled machine-learned model 1. For instance, model host 31 can implement a smaller version of a larger model. For example, model host 31 can implement (e.g., store, execute, etc.) a student machine-learned model that was distilled from a larger teacher machine-learned model according to example aspects of the present disclosure.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

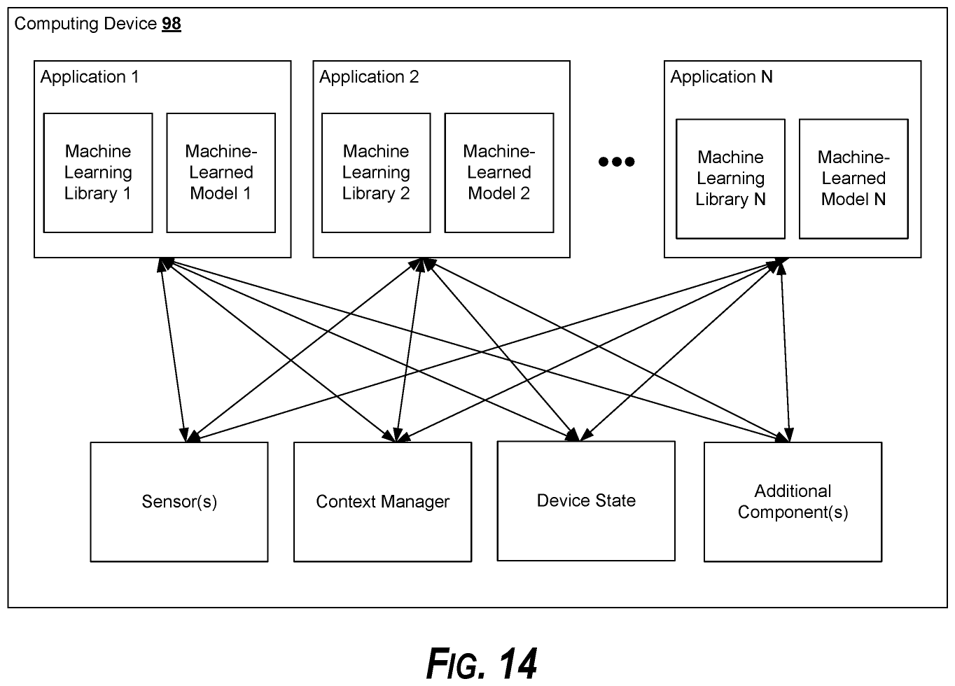

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

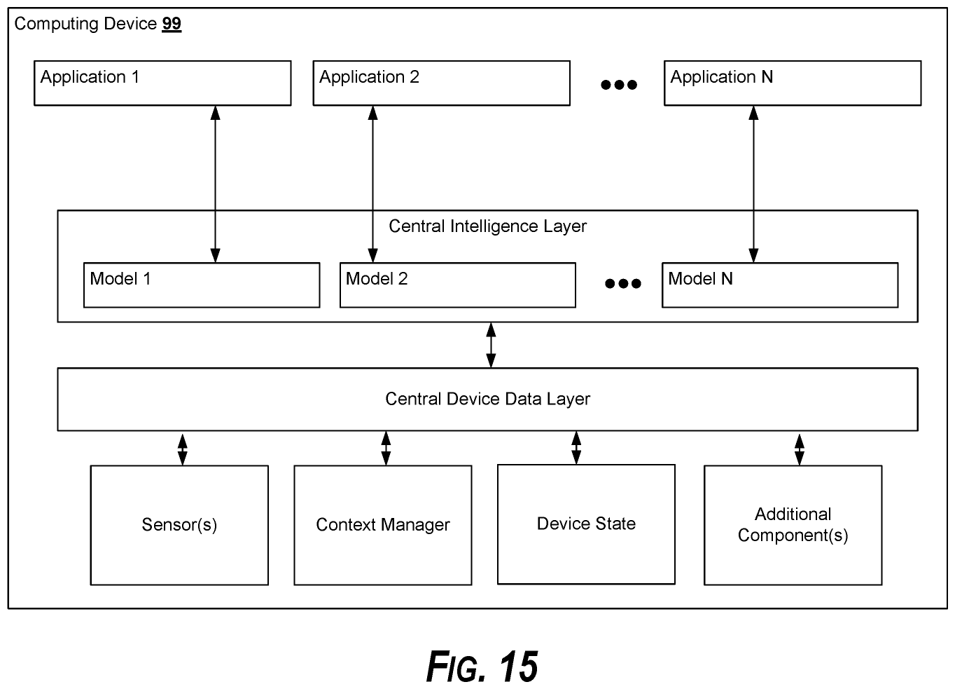

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for training a machine-learned student sequence processing model, the method comprising:
obtaining a respective input;
obtaining, from the student machine-learned sequence processing model, a respective output corresponding to the respective input;
generating a multiscale refinement objective configured to jointly distill knowledge from a teacher machine-learned sequence processing model and reinforce preferred behavior of the student machine-learned sequence processing model,
wherein the multiscale refinement objective comprises:
a first component based on a divergence metric characterizing, for the respective input, a comparison of a plurality of predictions of the student machine-learned sequence processing model to a plurality of predictions of the teacher machine-learned sequence processing model; and
a second component based on a reinforcement learning signal associated with the respective output; and
updating the machine-learned student sequence processing model based on the multiscale refinement objective.

2. The method of claim 1, wherein the divergence metric is evaluated using:
a student value generated by the machine-learned student sequence processing model for one or more portions of the respective output based on the respective input, the value corresponding to a student probability of the one or more portions of the respective output conditioned on the respective input; and
a teacher value generated by the machine-learned teacher sequence processing model for the one or more portions of the respective output based on the respective input, the teacher value corresponding to a teacher probability of the one or more portions of the respective output conditioned on the respective input.

3. The method of claim 1, comprising:
for each portion of a plurality of portions of the respective output:
determining a portion-specific divergence metric that characterizes a similarity between a student probability distribution over a set of candidate output portions and a teacher probability distribution over the set of candidate output portions, wherein each of the student probability distribution and the teacher probability distribution are conditioned on the respective input and one or more portions of the respective output that precede the portion; and
aggregating the plurality of portion-specific divergence metrics for the respective output to obtain the first component.

4. The method of claim 3, wherein the teacher probability distributions for each of the portion-specific divergence metrics are generated at least partially in parallel by the machine-learned teacher sequence processing model.

5. The method of claim 1, wherein the multiscale refinement objective comprises one or more weighting parameters that weight the respective contributions of the first component and the second component.

6. The method of claim 1, wherein the reinforcement learning signal comprises data indicating human feedback on an overall quality of the respective output.

7. The method of claim 1, wherein the reinforcement learning signal comprises data indicating a score generated by a machine-learned reward model, wherein the score indicates an overall quality of the respective output.

8. The method of claim 1, wherein evaluating the divergence metric comprises:
determining a value of a mixture distribution corresponding to a mixture of a student probability distribution of the machine-learned student sequence processing model and a teacher probability distribution of the machine-learned teacher sequence processing model;
computing a first divergence component that characterizes a divergence of the student probability distribution with respect to the mixture distribution;
computing a second divergence component that characterizes a divergence of the teacher probability distribution with respect to the mixture distribution; and
evaluating the divergence metric based on a combination of the first divergence component and the second divergence component.

9. The method of claim 8, wherein evaluating the divergence metric based on the first divergence component and the second divergence component comprises:
computing, using a weighting parameter, a weighted combination of the first divergence component and the second divergence component.

10. The method of claim 9, wherein adjusting the weighting parameter causes the divergence metric to interpolate between a mode-seeking behavior and a mean-seeking behavior.

11. The method of claim 10, comprising:
adjusting the weighting parameter based on a desired output diversity for a type of task.

12. The method of claim 11, wherein the weight is a learned hyperparameter during training.

13. The method of claim 1, wherein the machine-learned teacher sequence processing model was not trained using reinforcement learning.

14. The method of claim 13, wherein the machine-learned student sequence processing model was fine-tuned to achieve a baseline threshold of performance before training with the multiscale refinement objective.

15. The method of claim 1, wherein:
the machine-learned student sequence processing model is characterized by a first number of parameters;
the machine-learned teacher sequence processing model is characterized by a second number of parameters; and
the second number of parameters is larger than the first number of parameters.

16. The method of claim 15, wherein the second number of parameters is at least 30 times the first number of parameters.

17. The method of claim 1, comprising:
receiving, from a client computing system, a request to perform an inference task based on input data;
obtaining the respective input from the input data;
generating the respective output using the machine-learned student sequence processing model;
returning, to the client computing system and responsive to the request, output data based on the respective output;
receiving, from the client computing system, feedback data; and
determining the reinforcement learning signal based on the feedback data.

18. The method of claim 17, comprising:
in an online process, receiving the request and returning the output data; and
in an offline process, obtaining the plurality of predictions of the teacher machine-learned sequence processing model and updating the machine-learned student sequence processing model based on the multiscale refinement objective.

19. A computing system, comprising:
one or more processors; and
one or more non-transitory computer-readable media storing instructions that are executable by the one or more processors to cause the computing system to perform one or more operations, the operations comprising:
obtaining a respective input;
obtaining, from a student machine-learned sequence processing model, a respective output corresponding to the respective input;
generating a multiscale refinement objective configured to jointly distill knowledge from a teacher machine-learned sequence processing model and reinforce preferred behavior of the student machine-learned sequence processing model,
wherein the multiscale refinement objective comprises:
a first component based on a divergence metric characterizing, for the respective input, a comparison of a plurality of predictions of the student machine-learned sequence processing model to a plurality of predictions of the teacher machine-learned sequence processing model; and
a second component based on a reinforcement learning signal associated with the respective output; and
updating the machine-learned student sequence processing model based on the multiscale refinement objective.

20. One or more non-transitory computer-readable media storing a machine-learned student sequence processing model that was distilled from a larger teacher machine-learned sequence processing model, wherein the machine-learned model was trained by:
obtaining a respective input;
obtaining, from the student machine-learned sequence processing model, a respective output corresponding to the respective input;
generating a multiscale refinement objective configured to jointly distill knowledge from the teacher machine-learned sequence processing model and reinforce preferred behavior of the student machine-learned sequence processing model,
wherein the multiscale refinement objective comprises:
a first component based on a divergence metric characterizing, for the respective input, a comparison of a plurality of predictions of the student machine-learned sequence processing model to a plurality of predictions of the teacher machine-learned sequence processing model; and
a second component based on a reinforcement learning signal associated with the respective output; and
updating the machine-learned student sequence processing model based on the multiscale refinement objective.
